(19) United States
(12) Patent Application Publication
(10) Pub. No.: US 2012/0170274 A1
(43) Pub. Date: Jul. 5, 2012

(54) MAGNIFYING LAMP WITH DETECTION FUNCTION

(76) Inventor: James LU, Guangdong Province (CN)

(21) Appl. No.: 12/981,457

(22) Filed: Dec. 29, 2010

(51) Int. Cl. F21V 33/00

(52) U.S. Cl. 362/253

(57) ABSTRACT

The present invention provides a magnifying lamp with detection function which comprises an illuminating lamp holder, a magnifying lens, a lamp arm and a lamp body fixation means, characterized in that an ultraviolet light source is disposed inside the illuminating lamp holder, and the ultraviolet light source is connected to a power supply of the magnifying lamp and controlled by a ultraviolet light source control switch. The present invention has the following advantages: In addition to the lighting and magnifying functions, the present magnifying lamp also provides other detection functions such as counterfeit banknote detection and so forth. Besides, the present invention is simple to assemble, convenient to operate and practical.

### BACKGROUND OF THE INVENTION

The present invention relates to a magnifying lamp which could be used for observation under magnification.

A magnifying lamp generally comprises an illuminating lamp holder, a magnifying lens, a lamp arm and a lamp body fixation means. The magnifying lens is disposed above the illuminating lamp holder. A cold cathode fluorescent lamp or multiple light-emitting diodes is/are used as a light source and the light source is disposed at an outer periphery of the magnifying lens. Power supply of the magnifying lamp generally transforms an 110V/220V alternating current into a direct current of a safe voltage for supplying to the light source so as to separate a dangerous voltage from the magnifying lamp. At the same time, a control circuit and a switch are configured to control the illuminating lamp and the power supply. For the sake of finer adjustment of the illuminating lamp holder's position, the lamp arm is generally adjustable. Due to low electrical power consumption and low voltage, magnifying lamp is very safe for human use and it could bring convenience to the visually impaired and to the elderly who suffered from poor eyesight. By using a magnifying lamp, it is also convenient to observe small objects, texts, FIGURES and so forth. Use of magnifying lamp is also fairly common in relation to works such as repairing of delicate and precise machinery, engraving and embroidering and among learners.

A disadvantage of existing magnifying lamps is that they perform only a single function and could not offer other practical functions to the visually impaired.

### BRIEF SUMMARY OF THE INVENTION

In order to improve the functionality of a magnifying lamp, the present invention provides a magnifying lamp with detection function.

The object of the present invention is attained by the following technical proposal: A magnifying lamp with detection function which comprises an illuminating lamp holder, a magnifying lens, a lamp arm and a lamp body fixation means, characterized in that an ultraviolet light source is disposed inside the illuminating lamp holder, and the ultraviolet light source is connected to a power supply of the magnifying lamp and controlled by an ultraviolet light source control switch.

More preferably, the ultraviolet light source is disposed around the magnifying lens.

More preferably, for the sake of convenient control, the ultraviolet light source control switch is disposed atop an outer casing of the illuminating lamp holder.

The present invention has the following advantages: In addition to the lighting and magnifying functions, the present magnifying lamp also provides other detection functions such as counterfeit banknote detection and so forth. Besides, the present invention is simple to assemble, convenient to operate and practical.

### BRIEF DESCRIPTION OF THE DRAWINGS

FIG. 1 illustrates the structure of the present invention.

In the FIGURE, 1 denotes an illuminating lamp holder, 2 denotes a magnifying lens, 3 denotes an ultraviolet light source, 4 denotes an ultraviolet light source control switch, 5 denotes a lamp arm and 6 denotes a lamp body fixation means.

### DETAILED DESCRIPTION OF THE INVENTION

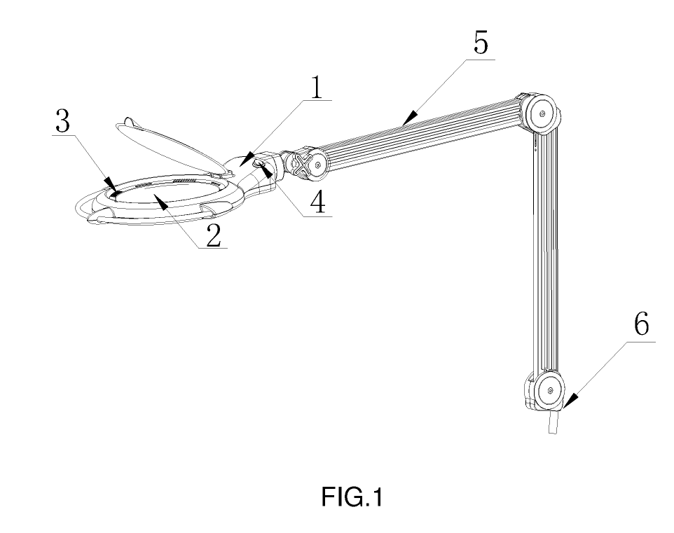

FIG. 1 illustrates a magnifying lamp with counterfeit banknote detection function which comprises an illuminating lamp holder 1, a magnifying lens 2, an ultraviolet light source 3, an ultraviolet light source control switch 4, a lamp arm 5 and a lamp body fixation means 6. The ultraviolet light source 3 is disposed around the magnifying lens 2. The ultraviolet light source 3 is connected to a power supply of the magnifying lamp and controlled by the ultraviolet light source control switch 4. For the sake of convenient control, the ultraviolet light source control switch 4 is disposed atop an outer casing of the illuminating lamp holder 1.

The present invention could be conveniently operated. By turning on the ultraviolet light source control switch 4 and placing a banknote under the light source of the magnifying lamp, it could be instantly identified if the banknote is counterfeit. The present invention is therefore very practical.

It should be noted that the ultraviolet light source 3 could be disposed at any position inside the illuminating lamp holder 1. The ultraviolet light source control switch 4 could also be disposed at other positions on the magnifying lamp according to different needs. Apart from counterfeit banknote detection, the ultraviolet light source 3 could also perform other detection functions. The above embodiment is only for illustrating the present invention but it should not be regarded as limiting the technical proposal as described in the present invention. Therefore, despite the detailed description of the present invention hereof with reference to the above embodiment, a skilled person in the art should understand that alteration and equivalent replacement could still be made to the present invention and all technical proposals and their modification not deviated from the spirit and scope of the present invention should fall into the scope of the claims of the present invention.

What is claimed is:

1. A magnifying lamp with detection function comprising an illuminating lamp holder, a magnifying lens, a lamp arm and a lamp body fixation means, characterized in that an ultraviolet light source is disposed inside the illuminating lamp holder, and the ultraviolet light source is connected to a power supply of the magnifying lamp and controlled by a ultraviolet light source control switch.

2. The magnifying lamp with detection function as in claim 1, characterized in that the ultraviolet light source is disposed around the magnifying lens.

3. The magnifying lamp with detection function as in claim 1 or 2, characterized in that the ultraviolet light source control switch is disposed atop an outer casing of the illuminating lamp holder.
